(19) United States
(12) Patent Application Publication
(10) Pub. No.: US 2003/0156826 A1
(43) Pub. Date: Aug. 21, 2003

(54) Scheduled recording and replaying of broadcast programs

(75) Inventors: Toshihiro Sonoda, Kawasaki (JP); Tomoyoshi Takebayashi, Kawasaki (JP); Toshihiro Azami, Kawasaki (JP); Fumio Honda, Kawasaki (JP); Yasuo Sato, Kawasaki (JP); Makoto Morioka, Kawasaki (JP); Shinichi Ono, Kawasaki (JP); Midori Fukai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/253,617

(22) Filed: Sep. 25, 2002

(30) Foreign Application Priority Data
Feb. 15, 2002 (JP) 2002-39018

(51) Int. Cl. H04N 5/76; G06F 3/00; G06F 13/00

(52) U.S. Cl. 386/83; 725/58

(57) ABSTRACT

A first program schedule of a receivable broadcast channel is stored in a memory device. A program in the first program schedule broadcast in a particular period of time is mapped into a second program schedule by a controller to thereby set a virtual channel including the second program schedule. When a user selects the virtual channel, the controller replays the broadcast program in accordance with the second program schedule of the virtual channel.

### FIELD OF THE INVENTION

This invention relates to scheduled recording and replaying of broadcast programs, and, more particularly to preparation of a virtual channel schedule and recording and replaying of broadcast programs in accordance with the prepared virtual channel schedule.

### BACKGROUND OF THE INVENTION

When recording a television broadcast program with a record/replay apparatus, a user may obtain an electronic program guide (EPG) from a particular satellite broadcast channel or from a Web site through the Internet, view it on a display device of a television apparatus, and select a desired program broadcast through a certain channel from the EPG for recording the desired program through the channel during a corresponding allocated period of time in the EPG.

Then, the user can watch the television broadcast programs recorded in a memory device of the record/replay apparatus according to a desired schedule by manually searching the recorded programs, remembering the schedule the user has memorized or seeing the schedule the user has written down.

It is known to map a normal television broadcast channel number to a different channel number. A user can watch and/or record television programs of the normal broadcast channel by selecting the different channel number.

It is, however, impossible to map a selected program of a particular television broadcast channel into a different channel.

Japanese Unexamined Patent Application Publication No. HEI 9-261616 A discloses a system in which a user can select desired programs from a list of distributed programs to thereby prepare a desired program schedule. The prepared program schedule is stored in a memory section of a terminal device. The terminal device sends a center requests for programs sequentially according to the stored program schedule, and the center sends the requested programs to the terminal device. This publication also discloses a system in which the user selects desired programs from the list of distributable programs through the terminal device to thereby prepare a list of programs booked for distribution. The list of programs is sent to the center, and the center sequentially sends the booked programs to the terminal device according to the list. It should be noted that the programs are not broadcast television programs.

The inventors have recognized that it may be useful if a virtual channel is provided in a video record and replay apparatus, into which programs broadcast through actual or real channels can be mapped as a user desires, whereby desired programs currently or previously broadcast through the actual channels can be viewed through the virtual channel, without worrying about the need for recording or playing back the programs.

An object of the present invention is to provide a apparatus which allows a user to map programs broadcast through actual broadcast channels into a virtual channel as the user desires so that the user can view the mapped programs through the virtual channel.

### SUMMARY OF THE INVENTION

In accordance with an aspect of the present invention, an apparatus includes a memory device for storing therein a first program schedule of a receivable broadcast channel, and control means for setting a virtual channel having a second program schedule by mapping a broadcast program in the first program schedule that is broadcast during a particular period of time into the second program schedule.

When the user selects the virtual channel, the control means may replay the broadcast program according to the second program schedule of the virtual channel.

The control means may record the broadcast program on a storage medium in accordance with the second program schedule of the virtual channel, and may delete the broadcast program stored on the storage medium in accordance with the second program schedule.

In accordance with another aspect of the present invention, a program stored on a storage medium for an information processing device is operable to effect the step of storing a first program schedule for a receivable broadcast channel, and the step of setting a virtual channel having a second program schedule by mapping a broadcast program in the first program schedule that is broadcast during a particular period of time into the second program schedule.

In accordance with a further aspect of the present invention, a method for setting a virtual channel for use in an information processing device includes the step of storing a first program schedule for a receivable broadcast channel, and the step of setting a virtual channel having a second program schedule by mapping a broadcast program in the first program schedule that is broadcast during a particular period of time into the second program schedule.

According to the present invention, a user is allowed to map desired broadcast programs broadcast in actual channels into a virtual channel and to view the broadcast programs through the virtual channel.

### BRIEF DESCRIPTION OF THE DRAWINGS

FIG. 1 shows an arrangement of an audio/video record and replay device in accordance with one embodiment of the present invention;

FIG. 2 shows an operation menu displayed by the audio/video record and replay device in accordance with the embodiment of the present invention;

FIG. 3A is an example of a broadcast program guide of one day, Monday, FIG. 3B shows an example of a program schedule of the same day on a virtual channel, and FIG. 3C shows an example of a program schedule of the next day, Tuesday, on the virtual channel;

FIG. 4 is a flow chart for producing and changing a virtual channel schedule, executed by a controller in accordance with a virtual channel processing program of the present invention;

FIG. 5 is a flow chart for recording audio/video programs in accordance with the virtual channel schedule, executed by the controller in accordance with the virtual channel processing program of the invention;

FIG. 6 is a flow chart for presenting audio/video programs through the virtual channel in accordance with the virtual channel schedule, executed by the controller in accordance with the virtual channel processing program of the invention;

FIG. 7 is a different flow chart for presenting audio/video programs through the virtual channel in accordance with the virtual channel schedule, executed by the controller in accordance with the virtual channel processing program of the invention; and

FIG. 8 is a flow chart for deleting a recorded audio/video program on the virtual channel in accordance with the virtual channel schedule, executed by the controller in accordance with the virtual channel processing program of the invention.

### DESCRIPTION OF PREFERRED EMBODIMENTS

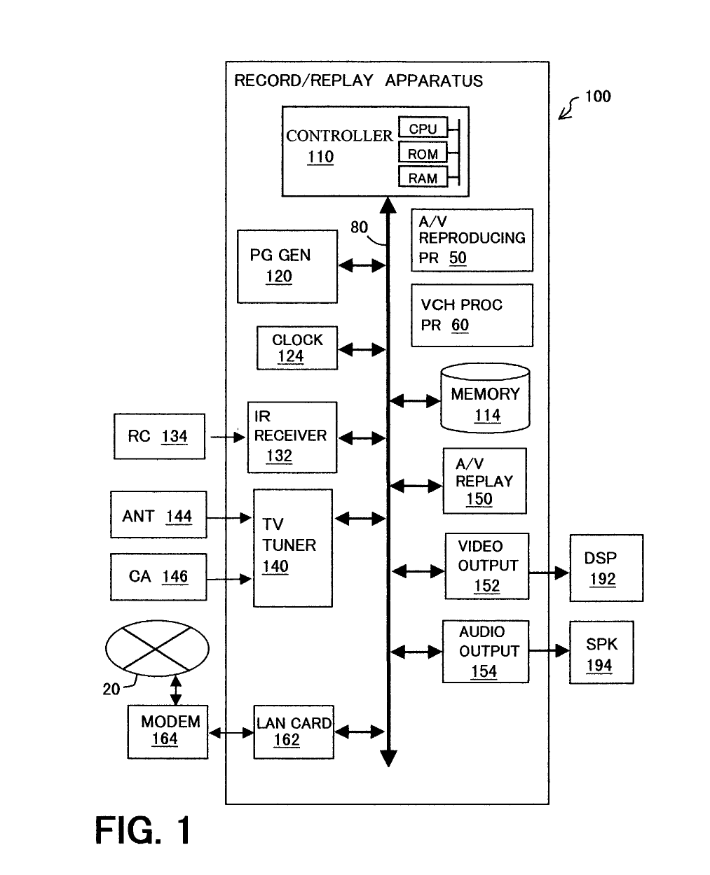

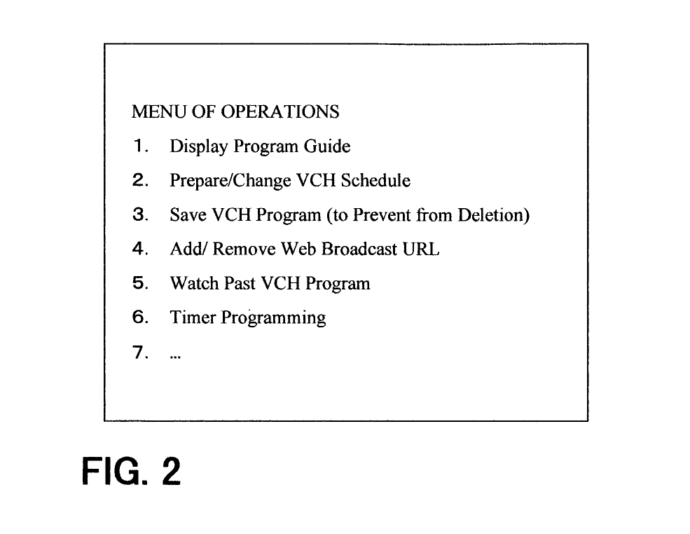

FIG. 1 shows an arrangement of an audio/video record and replay apparatus 100 in accordance with one embodiment of the present invention. The record and replay apparatus 100 includes a controller 110, such as a microcontroller including a CPU, a ROM and a RAM, a memory device 114, such as a hard disk device, a program guide generating unit more module 120, a clock 124, an infrared (IR) receiver 132, a built-in card type television tuner unit 140, an audio/video reproducing module 150, a video output unit 152, an audio output unit 154, and a LAN card 162. These components are interconnected via an internal bus 80.

The record and replay apparatus 100 may be an information processing apparatus, e.g. a desktop personal computer, a notebook-sized personal computer, a digital video record/replay apparatus, or a television apparatus with recording and replaying features.

The IR receiver 132 receives an infrared signal containing control commands, such as a command to select a receiving channel, from a remote controller 134.

The television tuner unit 140 has at least two tuners for tuning to at least two television channels simultaneously, and is coupled to a terrestrial and/or satellite broadcast receiving antenna 144 external to the apparatus 100 and to a cable television (CATV) receiving cable 146.

The video output unit 152 is coupled to a display device 192, and an audio output unit 154 is coupled to a loudspeaker 194.

The LAN card 162 is coupled to an external ADSL modem 164 connected to a network 20, such as the Internet.

The audio/video reproducing module 150, which may be implemented in the form of hardware, includes a decoder, such as a MPEG2 decoder and a RealPlayer, implemented in the form of hardware or software. The MPEG2 decoder is used to decode and reproduce audio and video data streams, and the RealPlayer is used to decode and reproduce audio and video data streams, which are Web broadcast contents. The audio/video reproducing module 150 receives a processed digital video data stream from the television tuner unit 140 and may provide the received data stream with processing such as pixel interpolation, pixel decimation and color matrix transform, to thereby form a video signal in a format suitable for display on the display device 192. It may be so arranged that the tuner unit 140 is responsible for part of the functions of the reproducing module 15. The reproduced audio and video data streams are applied to the audio output unit 154 and the video output unit 152, respectively.

A virtual channel (VCH) processing program 60 in accordance with the present invention and other control programs are stored in the memory device 114 or in a memory device, such as the ROM or RAM in the controller 110. The audio/video reproducing module 150 may be implemented and stored in a memory in the form of an audio/video replay program 50 which is to be executed by the controller 110.

Now, the operation of the record and replay apparatus in accordance with the present invention is described.

A user presses down a key on the remote controller 134 to send a command for generating a menu to be displayed, and the controller 100 of the record and replay apparatus 100 receives the command through the IR receiver 132, to cause a menu of operations shown in FIG. 2 to be displayed on the display device 192. The operation menu contains items including “Display Program Guide”, “Prepare and Change VCH Schedule”, “Save VCH Program (to Prevent from Deletion)”, “Add/Remove Web Broadcast URL”, “Watch Past VCH Program”, and “Timer Programming”.

The program guide generating unit 120 operates to access a broadcast program guide Web page over the Internet and also receive EPGs through a particular channel of terrestrial broadcast, satellite broadcast, CATV broadcast and the like, periodically, for example, at one o'clock in the morning of every day or at one o'clock in the morning of every Saturday. The unit 120, then, captures electronic program guides for a given period of time, such as for one day or for one week, and stores them in the memory device 114, and produces a combined TV program guide including terrestrial, satellite, CATV and Web broadcast program identifications, such as broadcast channels, titles and allocated periods of time. The combined TV program guide is stored in the memory device 114. The URL of the Web broadcast is set by the user entering necessary data or accessing the Web page, and saving the URL.

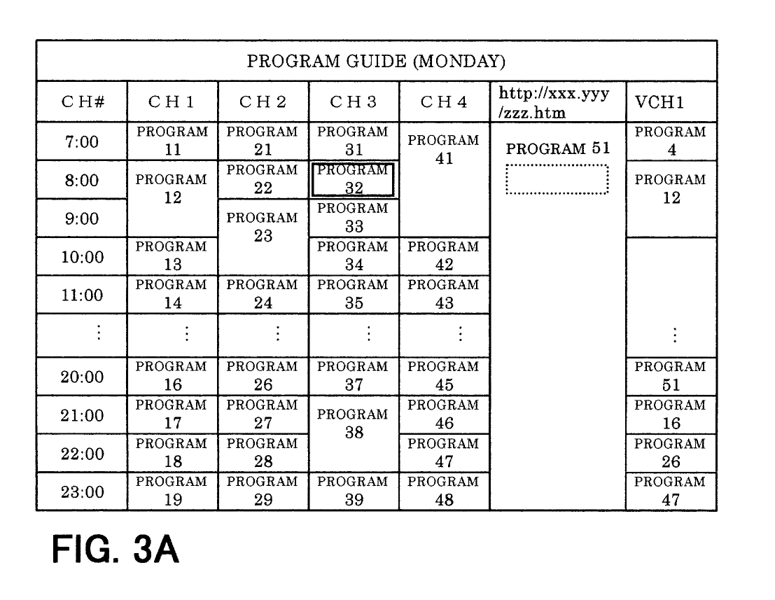

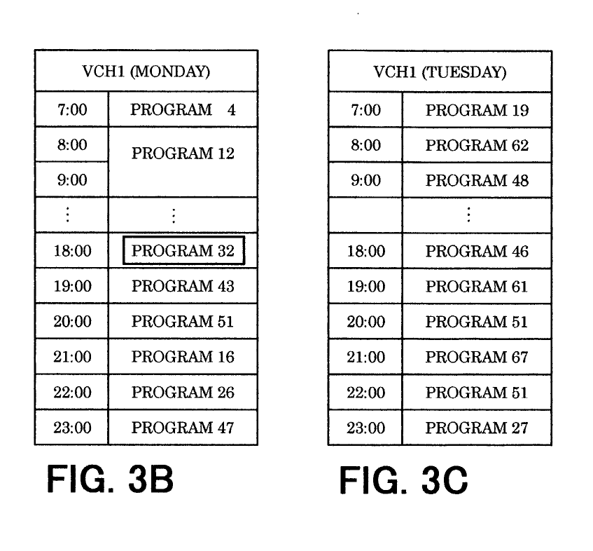

FIG. 3A is an example of the combined program guide for one day, Monday as an example. It should be noted that no program identifications appears in the rightmost column “VCH 1” when the virtual channel schedule has not been set.

In FIG. 3A, columns labeled “CH1”, “CH2”, “CH3” and CH 4 are for terrestrial, satellite and CATV broadcast channels, and a column labeled a URL “http://xxx.yyy/zzz.htm” is for programs broadcast on a Web site. The name of Web broadcast may be used in place of the URL.

The leftmost column is for periods of time or time slots. In the illustrated example, each period of time starts on the hour and continues one hour.

In the channels CH1 through CH4, titles or identifications of programs broadcast in the respective periods of time are displayed as “PROGRAM 11” through “PROGRAM 48”. In the column for the URL, a title of one program is displayed as “PROGRAM 51”. Here, it is assumed that the Web site provides only one program, such as a news program or music program, but a user can select a desired period of time during which the user can watch PROGRAM 51.

The user operates the remote controller 134 to point to “Display Program Guide” in the menu shown in FIG. 2 and presses down an “Execute” or “OK” key on the remote controller 134. In response to it, the controller 110 gives an activating instruction to the program guide generating unit 120. In response to the instruction, the generating unit 120 generates a program guide signal to display the program guide shown in FIG. 3A on the display device 192.

FIGS. 3B and 3C show examples of a program schedule for one day and for the next day for the virtual channel (VCH1) which is prepared in a procedure described later. As shown in FIG. 3A, a schedule of programs of the virtual channel VCH1 is incorporated into the VCH1 column in the combined program guide of one day (Monday) and displayed if the virtual channel VCH1 of the same day as shown in FIG. 3B has been set.

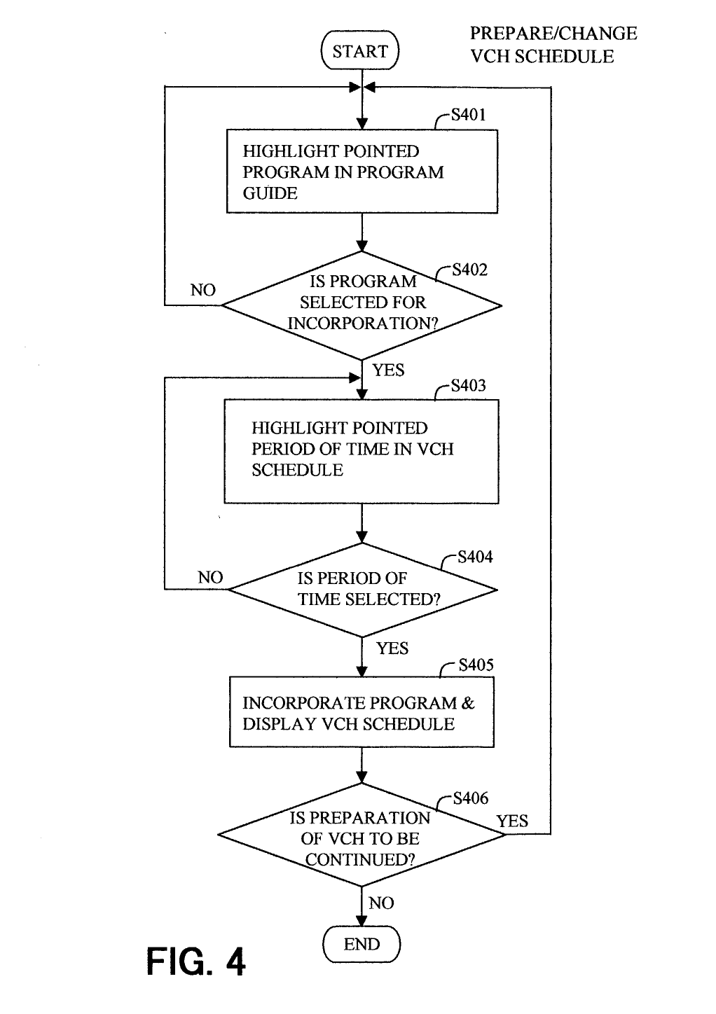

FIG. 4 is a flow chart for preparing and changing a virtual channel schedule, executed by the controller 110 in accordance with the virtual channel processing program 60. The user operates the remote controller 134 to point to the item “Prepare and Change Virtual Channel Schedule” in the menu shown in FIG. 2 and presses down the “OK” key on the remote controller 134 for activating the process. Then, the controller 110 invokes the virtual channel processing program 60 for executing the procedure for preparing and changing the virtual channel schedule in accordance with the flow chart shown in FIG. 4.

In the flow chart shown in FIG. 4, the controller 110, at Step 401, activates the program guide generating unit 120 to cause the program guide shown in FIG. 3A and the virtual channel schedule of the same day shown in FIG. 3B to be displayed on the display device 192. When these program guide and schedule are first displayed, the column for the virtual channel VCH1 in the program guide is blank.

The user operates the remote controller 134 to point to a field of a particular program identification in the program guide shown in FIG. 3A, for example, PROGRAM 32 on the channel CH3 broadcast from 8:00 to 9:00 in the morning. Then, the program identification is highlighted by, for example, being inverted or blinking. In the example shown in FIG. 3A, the highlighting is indicated by enclosing the program title in a bold line square. After that, the “OK” key is pressed down so that PROGRAM 32 can be selected for incorporation into the virtual channel schedule shown in FIG. 3B.

If the desired program is PROGRAM 51 for the Web broadcast, the user points to a desired period or periods of time in PROGRAM 51 (for example, from 8:00 to 9:00) through the remote controller 134 so that the pointed periods of time in PROGRAM 51 is highlighted. Alternatively, the user may directly enter the period of time, i.e. start time and end time, through the remote controller 134. After that, the user presses the “OK” key on the remote controller 134 to select PROGRAM 51 in the selected period of time for incorporation into the virtual channel schedule.

At Step 402, the controller 110 periodically determines as to whether or not a particular program has been selected for incorporation into the virtual channel schedule. If it is determined that a particular program has been selected, the procedure advances to Step 403. If it is determined that no program has been selected yet, the procedure returns to Step 401, and the user is allowed to continue selection of the programs.

When the user selects a particular program for incorporation into the virtual channel schedule, the virtual channel schedule, shown in FIG. 3B, for the same day, Monday, as the combined program guide shown in FIG. 3A, is displayed as a default virtual channel schedule. At Step 403, the controller 110 instructs the user to use the remote controller 134 to point to a desired period of time in position in the virtual channel schedule where the selected program is to be mapped. In this case, the user, through the operation of the remote controller 134, can change the virtual channel schedule displayed on the screen to a virtual channel schedule for another day to map the selected program into it.

The controller 110 instructs the user to use the remote controller 134 to point to the period of time in the virtual channel schedule in which the user intends to watch the broadcast program selected at Step 402. The pointed period of time is highlighted. In the example illustrated in FIG. 3B, the period of time of from 18:00 to 19:00 of Monday is pointed and highlighted, being represented by enclosing it in a bold line square in FIG. 3B.

The program in the virtual channel schedule can be changed or altered in the same manner. For that purpose, the user may select a particular period of time of the virtual channel schedule into which a program has been already mapped.

A period of time in the virtual channel schedule into which a selected program can be mapped is restricted to the same period of time of the same day as or a period of time later than that selected program is actually broadcast. The user can not select a period of time against this restriction. If the user tries to select a period of time against the restriction at Step 403, an on-screen display caution may be provided to notify the user that such selection is not allowed. Alternatively, the earliest period of time the user is allowed to select may be indicated on the virtual channel schedule, so that the user may select the indicated period of time or a later one.

The number of programs in the program guide, shown in FIG. 3A, broadcast in the same period of time which can be mapped into the virtual channel schedule may be limited by factors including the number of tuners in the tuner unit 140 and the processing ability of the record and replay apparatus 100. If the user tries to select an excessive number of programs in the program guide in FIG. 3A at Step 403, an on-screen display caution indicating that such selection is not permitted may be provided on the display device 192.

Next, the user presses down the execution or OK key on the remote controller 134 to determine the selection of the period of time in the virtual channel schedule.

At Step 404, the controller 110 periodically determines as to whether or not a particular period of time in the virtual channel schedule has been selected. If it is determined that such a particular period of time has been selected, the procedure advances to Step 405. If it is determined that no period of time has been selected, the procedure returns to Step 403, and the selection of period of time by the user is continued.

At Step 405, the controller 110 causes the selected program identification to be displayed in the selected period or periods of time in the virtual channel schedule shown in FIG. 3B.

At Step 406, the controller 110 generates an on-screen display on the display device 192 to ask the user whether or not to continue the preparation of the virtual channel schedule. If the user selects continuing the preparation, the procedure returns to Step 401. If the user selects discontinuation, the procedure exits the routine of FIG. 4. The flow chart shown in FIG. 4 is also applicable when a program in the virtual channel schedule is changed to another one. A program in the virtual channel schedule may be cancelled by pressing down a cancel key on the remote controller 134.

The virtual channel schedule shown in FIG. 3B is described. In the period of time of from 7:00 to 8:00, PROGRAM 4 which is actually broadcast one or more days before the day of the program guide shown in FIG. 3A has been mapped. In the period of time of from 8:00 to 10:00, PROGRAM 12 broadcast through the channel CH1 in the same period of time on the same day (Monday) in the program guide shown in FIG. 3A has been mapped. PROGRAM 32 broadcast through the channel CH3 on the same day is mapped in the period of time of from 18:00 to 19:00. PROGRAM 43 broadcast through the channel CH4 on the same day is mapped into the period of time of from 19:00 to 20:00, and Web broadcast PROGRAM 51 in the period of time 8:00-9:00 indicated in the column for the Web broadcast by a dotted line square in FIG. 3A is mapped in the period of time of from 20:00 to 21:00 into the virtual channel schedule. Similarly, PROGRAM 16 broadcast through the channel CH1, PROGRAM 26 broadcast through the actual or real channel CH2, and PROGRAM 47 broadcast through the channel CH4 are mapped into the period of time of from 21:00 to 22:00, the period of time of from 22:00 to 23:00, and the period of time of from 23:00 to 24:00 of the virtual channel schedule, respectively.

FIG. 3C shows an example of the virtual channel schedule of the next day (Tuesday), into which PROGRAMS 19, 48, 46, 51 and 27 in the program guide of Monday shown in FIG. 3A are mapped. PROGRAMS 62, 61 and 67 which are to be broadcast through some actual channels on the next day (Tuesday) are also mapped.

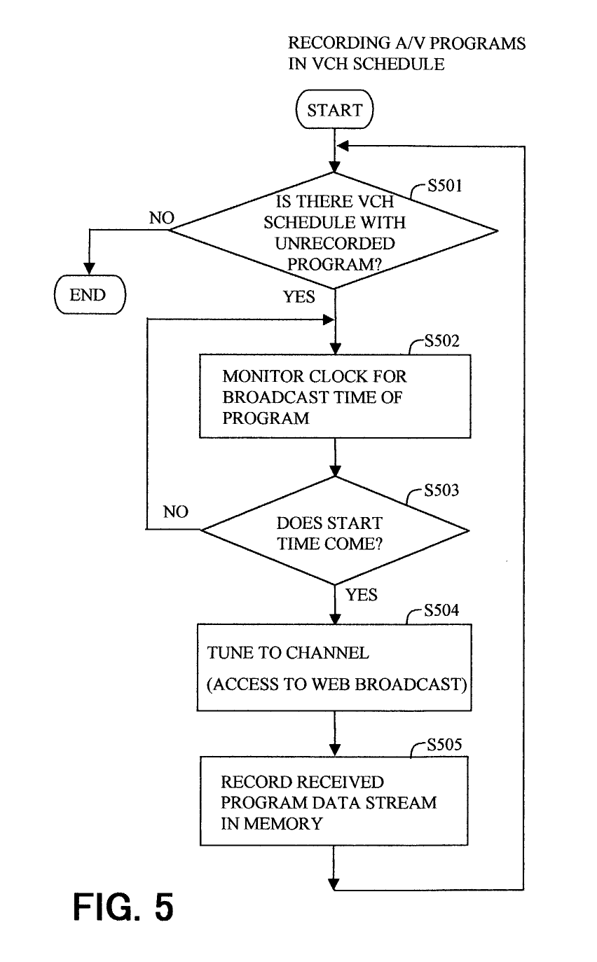

FIG. 5 is a flow chart for recording audio/video programs in accordance with the virtual channel schedule, executed by the controller 110 in accordance with the virtual channel processing program 60. After the virtual channel schedule has been set in accordance with the flow chart shown in FIG. 4, the controller 110 performs audio/video recording of mapped programs in the virtual channel schedule in accordance with the flow chart shown in FIG. 5.

At Step 501 shown in FIG. 5, the controller 110 determines whether or not there is a virtual channel schedule including an unrecorded program. If it is determined that there is a virtual channel schedule including an unrecorded program, the procedure advances to Step 502. If not, the procedure exits the routine of FIG. 5.

At Step 502, the controller 110 monitors the clock 124 for the time when the actual program in the combined program guide (FIG. 3A) corresponding to each mapped program in the virtual channel schedule is to be broadcast, referring to the period of time of the actual program in the program guide.

At Step 503, the controller 110 checks the time as to whether the program in the virtual channel schedule shown in FIG. 3B will start in a moment (for example within two seconds). If it is determined that the program starting time is coming near, the procedure advances to Step 504. If not, the procedure returns to Step 502.

At Step 504, the controller 110 tunes one of the tuners in the tuner unit 140 to the corresponding actual broadcast channel at the starting time of the program. If a plurality of programs in the virtual channel schedule start at the same time, the tuners in the tuner unit 140 are tuned to the actual broadcast channels of the respective programs. If the actual program is a Web broadcast program, a Web browser or the like is used to receive the Web broadcast program from a corresponding Web site over the network 20 through modem 164 and the LAN card 162.

At Step 505, the controller 110 captures the received audio/video data streams of the program on the corresponding actual channel during the program broadcast period of time and record them in the memory device 114. After the start of the recording, the procedure returns to Step 501. When a program in the virtual channel schedule starts while another program is being recorded, the recording of the former program is started, whereby both programs are recorded.

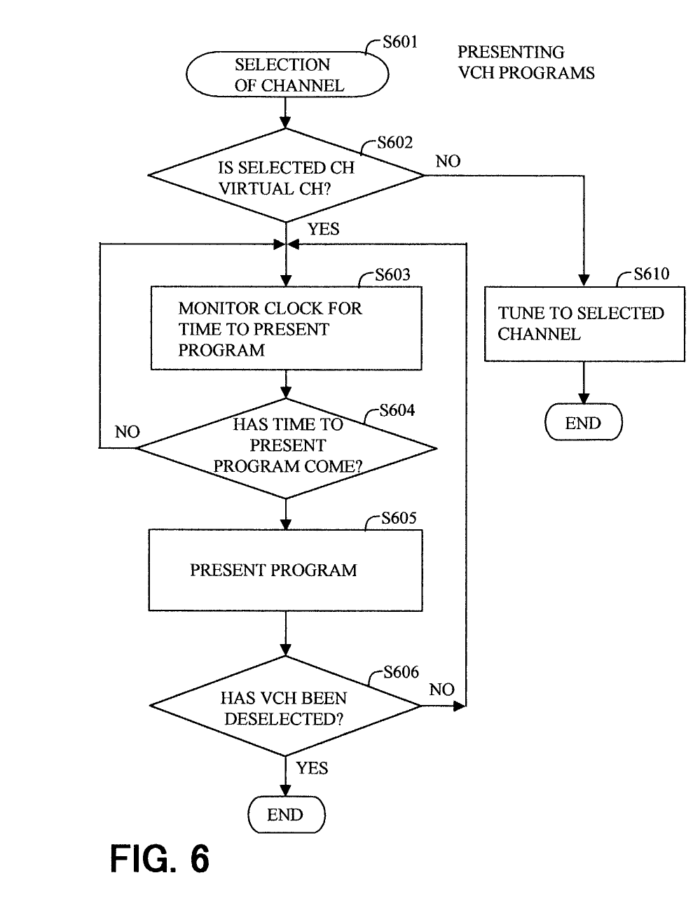

FIG. 6 is a flowchart for presenting audio/video programs through the virtual channel in accordance with the virtual channel schedule, executed by the controller 110 in accordance with the virtual processing program 60.

After the virtual channel schedule has been set in accordance with the flow chart shown in FIG. 4, the controller 110 operates, in accordance with the flow chart of FIG. 6, to provide the reproduced audio and video signals of the virtual channel programs to the display device 192 and the loudspeaker 194, respectively.

At Step 601 shown in FIG. 6, the user selects a desired channel for watching, and the controller 110 determines at Step 602 whether or not the selected channel is the virtual channel VCH1. If it determined that the virtual channel has been selected, the procedure advances to Step 603.

If it is determined that the user has selected a channel other than the virtual channel, the procedure advances to Step 610, where the controller 110 tunes the tuner to the selected channel, or starts receiving a Web broadcast program from a Web broadcast site. Then, the procedure exits the routine shown in FIG. 6. The controller 110 causes the received audio and video data streams to be supplied to the audio/video reproducing module 150 from the tuner unit 140 or from the LAN card 162. The reproduced signals from the reproducing module 150 are applied to the loudspeaker 194 and the display device 192.

At Step 603, the controller 110 monitors the clock 124 for the time, as in a manner similar to Step 502 in FIG. 5, in accordance with the virtual channel schedule.

At Step 604, the controller 110 determines, at a time when the virtual channel is selected or at a later time, whether the time for an unviewed program, i.e. a program which has not been presented yet, in the virtual channel schedule shown in FIG. 3B, to be presented will come soon or has already come. The procedure advances to Step 605, if it is determined that the time will come soon or the time has come already, but the virtual channel program to be presented has not been presented yet. The procedure advances to Step 605 also when the time for the next new program to be presented has come.

If it is determined that the time will not come soon or that the time has come already, the procedure returns to Step 603.

At Step 605, the controller 110 retrieves, from the memory device 114, the audio and video data streams of the corresponding recorded program and supplies them to the reproducing module 150. The reproduced signals from the audio output unit 154 and from the video output unit 152 are supplied to the loud speaker 194 and the display device 192, respectively.

If the program is being broadcast currently, the tuner is tuned to it at Step 504 shown in FIG. 5, and the program is recorded and, at the same time, presented to the loud speaker 194 and the display device 192. Alternatively, the program may be only presented to them without being recorded.

If the time when the virtual channel is selected at Step 601 is after the starting time of a virtual channel program and within the time period when the program is to be presented, the program is presented from the portion of the program corresponding to the time at which the virtual channel is selected.

Alternatively, the program may be replayed from the beginning. In this case, the replay of the program may be interrupted when the starting time of the next scheduled program comes. Alternatively, the replay may be continued to the end of the program by monitoring the clock 124 for the delayed time, which results in delaying the replay of the programs as a whole.

At Step 606, the controller 110 determines whether the virtual channel has been deselected or deactivated. If it is determined that the virtual channel has been deselected, the procedure exits the routine shown in FIG. 6. If not, the procedure returns to Step 603.

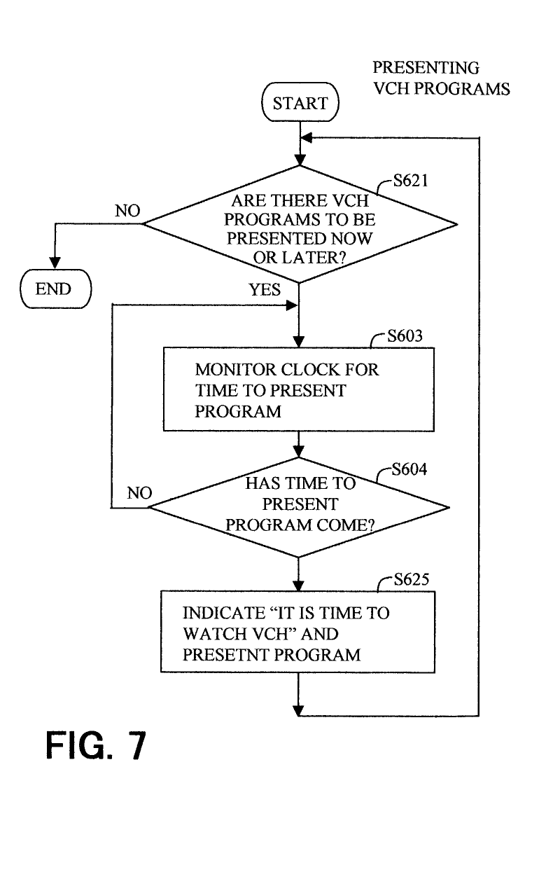

FIG. 7 is another example of a flow chart for presenting audio/video programs through the virtual channel in accordance with the virtual channel schedule, executed by the controller 110 in accordance with the virtual channel processing program 60. This flow chart is an alternative to the one shown in FIG. 6. Steps 603 and 604 in FIG. 7 are the same as those of FIG. 6. When the virtual channel schedule is set in accordance with the flow chart shown in FIG. 4, the controller 110 executes the routine shown in FIG. 7 to present the virtual channel programs.

At Step 621 shown in FIG. 7, the controller 110 determines whether there is a virtual channel schedule, programs of which are to be presented now or in the future. If it is determined that there is such a virtual channel schedule, the procedure advances to Step 603. If not, the procedure exits the routine. Steps 603 and 604 are executed in a manner similar to the ones in the flow chart shown in FIG. 6.

At Step 625, the controller 110 first causes the display device 192 to display the fact that the time for watching a new or unviewed program has come, and also causes the loudspeaker 194 to generate a beep or an announcement, to thereby notify the user of the fact. Upon selection of the virtual channel by the user, the controller 110 starts reproduction of the program data streams. For that purpose, the controller 110 operates in the same manner as at Step 605 shown in FIG. 6.

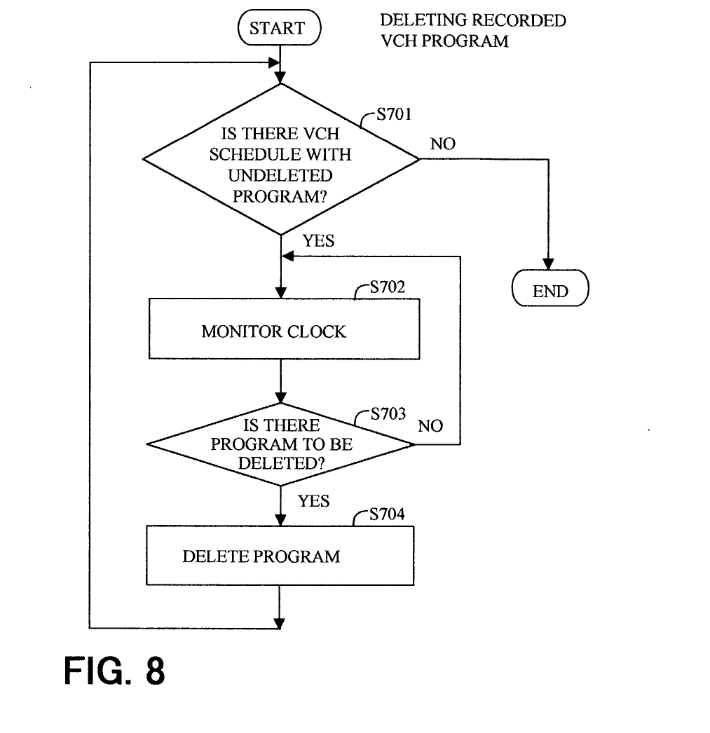

FIG. 8 is a flow chart for deleting a recorded audio/video program on the virtual channel in accordance with the virtual channel schedule, executed by the controller 110 in accordance with the virtual channel processing program 60.

At Step 701 shown in FIG. 8, the controller 110 checks the recorded data in the memory device 114 as to whether there is a virtual channel schedule containing a program which has not been deleted, even after the time at which the program is to be presented or replayed has elapsed. If it is determined that there is a virtual channel schedule containing such an undeleted program, the procedure advances to Step 702. If it is determined that there is not such a virtual channel schedule, the procedure exits the routine shown in FIG. 8.

At Step 702, the controller 110 monitors the clock 124 for the time, referring to the period of time of the past programs in the virtual channel schedule.

At Step 703, the controller 110 determines as to whether or not there is a program to be deleted in the memory device 114. What is meant by “program to be deleted” is a program which has been presented or replayed, a program presented or replayed a predetermined time before (e.g. 24 hours before), or a program scheduled to be presented or replayed a predetermined time before (e.g. 48 hours before) regardless whether the program was actually presented or not. The last case may be modified so that programs which was scheduled to be presented or replayed a predetermined time before and have been already presented or replayed may be deleted, while programs which have not yet been presented or replayed may be saved for an additional time or until it is actually replayed.

Whether a particular program has been presented or not can be determined by seeing whether at least part of the program has been presented at Steps 602-605 in the flow chart shown in FIG. 6 or at Step 625 in FIG. 7, or seeing whether at least part of the program has been replayed through the use of a function “Watch Past Virtual Channel Program” shown in FIG. 2 and described later. The determination may be made by saving a record of time of the day of presentation of at least part of the program in the memory device 114 and by checking it later when it becomes necessary.

Alternatively, whether or not a particular program has been presented can be determined by seeing whether the entire program (from the beginning to the end of the program) has been presented at Steps 602-605 in the flow chart shown in FIG. 6, whether the entire program has been presented at Step 625 in the flow chart shown in FIG. 7, or whether the entire program has been replayed through the use of the function “Watch Past Virtual Channel Program” shown in FIG. 2. The determination may be made by storing one or more records of the replayed period or periods of time of the program in the memory device 114, and checking it later.

If it is determined that there is a program to be deleted, the procedure advances to Step 704. If it is determined that there is no program to be deleted, the procedure returns to Step 702.

At Step 704, the controller 110 deletes the program to be deleted. If the user wants a particular program to be undeletable, he or she uses the remote controller 134 to cause the menu shown in FIG. 2 to be displayed, selects an item “Save VCH Program (to Prevent from Deletion)”, further selects the virtual channel schedule shown in FIG. 3B, selects the particular program in it, and presses down the execution or OK key, so that the program is prevented from being deleted at Step 704. The user can sets a period of time for which the program should be saved, e.g. 24 hours, a week, a month, or semi-permanent period (i.e. a time period until the program is deleted by the user). After Step 704, the procedure returns to Step 701.

Before a program is deleted in accordance with the flow chart of FIG. 8, the user can watch it by selecting an item “Watch Past VCH Program” in the menu shown in FIG. 2, and selecting the past program in the virtual channel schedule to watch it again.

In the above-described example, there is provided only one virtual channel, but another virtual channel (e.g. VCH2) may be provided, for which processing similar to the one described above with respect to VCH1 can be provided.

The above-described embodiment is only a typical example, and its modifications and variations are apparent to people skilled in the art. It should be noted that people skilled in the art can make various modifications to the above-described embodiment without departing from the principle of the invention and the accompanying claims.

What is claimed is:

1. An apparatus comprising:
a memory device for storing therein a first program schedule of a receivable broadcast channel; and
control means for mapping a broadcast program in said first program schedule broadcast in a particular period of time into a second program schedule to thereby set a virtual channel including said second program schedule.

2. The apparatus according to claim 1 wherein said first program schedule includes a plurality of first program schedules in different broadcast forms.

3. The apparatus according to claim 1 wherein, when said virtual channel is selected by a user, said control means replays said broadcast program in accordance with said second program schedule of said virtual channel.

4. The apparatus according to claim 1 wherein, when said virtual channel is selected by a user, said control means replays a portion of said broadcast program which is to be currently presented in accordance with said second program schedule of said virtual channel.

5. The apparatus according to claim 1 wherein said control means maps said broadcast program into said second program schedule in a period of time corresponding to said particular period of time or in a later period of time.

6. The apparatus according to claim 1 wherein said control means prevents mapping into said second program schedule in a period of time which is earlier than said particular period of time in said first program schedule.

7. The apparatus according to claim 1 wherein said control means further receives a broadcast program in accordance with said second program schedule of said virtual channel.

8. The apparatus according to claim 1 wherein, when said virtual channel is selected by a user, said control means presents a broadcast program which is being received if said broadcast program is scheduled to be presented currently in accordance with said second program schedule of said virtual channel.

9. The apparatus according to claim 1 wherein said control means can cause said broadcast program to be recorded on a storage medium in accordance with said second program schedule of said virtual channel.

10. The apparatus according to claim 1 wherein said control means causes said broadcast program to be recorded on a storage medium in accordance with said second program schedule of said virtual channel and causes said broadcast program on said storage medium to be deleted in accordance with said second program schedule of said virtual channel.

11. The apparatus according to claim 9 wherein said control means prevents deletion of said broadcast program recorded on said storage medium for at least a predetermined period of time.

12. The apparatus according to claim 9 wherein, when said broadcast program is selected from said second program schedule by the user at a later time than the time at which said broadcast program is to be presented, said control means causes said broadcast program to be replayed only if said broadcast program is saved on said storage medium.

13. A program stored on a storage medium, for an information processing apparatus, said program being operable to effect the steps of:
storing a first program schedule of a receivable broadcast channel; and
setting a virtual channel including a second program schedule by mapping a broadcast program broadcast in a particular period of time in said first program schedule into said second program schedule.

14. The program according to claim 13 being operable to further effect the step of replaying said broadcast program in accordance with said second program schedule of said virtual channel, when said virtual channel is selected by a user.

15. The program according to claim 13 being operable to further effect the step of replaying a portion of said broadcast program which is to be currently presented in accordance with said second program schedule of said virtual channel, when said virtual channel is selected by a user.

16. The program according to claim 13 being operable to further effect the step of receiving a broadcast program in accordance with said second program schedule of said virtual channel.

17. The program according to claim 13 being operable to effect the step of presenting said broadcast program being currently received if said broadcast program being currently received is scheduled to be presented currently in accordance with said second program schedule, when a user select said virtual channel.

18. The program according to claim 13 being operable to further effect the steps of:
recording said broadcast program on a storage medium in accordance with said second program schedule of said virtual channel; and
deleting said recorded broadcast program in accordance with said second program schedule of said virtual channel.

19. The program according to claim 13 being operable to further effect the steps of:
recording said broadcast program on a storage medium in accordance with said second program schedule of said virtual channel; and
preventing deletion of said recorded broadcast program for at least a predetermined period of time.

20. A method for setting a virtual channel for use in an information processing apparatus, comprising the steps of:
storing a first program schedule of a receivable broadcast channel; and
setting a virtual channel including a second program schedule by mapping a broadcast program broadcast in a particular period of time in said first program schedule into said second program schedule.
